(19) United States
(12) Patent Application Publication
(10) Pub. No.: US 2013/0284380 A1
(43) Pub. Date: Oct. 31, 2013

(54) FEEDER

(71) Applicants: TSUNG-CHIH TSAI, Tu-Cheng (TW); SHANG-YU LIN, Tu-Cheng (TW); CHAO-AN KANG, Tu-Cheng (TW)

(72) Inventors: TSUNG-CHIH TSAI, Tu-Cheng (TW); SHANG-YU LIN, Tu-Cheng (TW); CHAO-AN KANG, Tu-Cheng (TW)

(21) Appl. No.: 13/661,345

(22) Filed: Oct. 26, 2012

(30) Foreign Application Priority Data
Apr. 27, 2012 (TW) 101115202

(51) Int. Cl. B32B 38/10

(52) U.S. Cl. 156/750

(57) ABSTRACT

A feeder capable of transferring and separating an adhesive component on a tap, includes a frame, a separator, and a drive device. The frame has a top portion for supporting the tap. The separator is mounted to the frame to separate the adhesive component from the tap when the tap passes through the separator. The drive device drives the tap to pass through the separator.

### BACKGROUND

1. Technical Field

The present disclosure relates to feeders, particularly to a label feeder.

2. Description of Related Art

A printed circuit board is often affixed with labels for identifying components or to show information about the printed circuit board. The labels are affixed to the printed circuit board manually. As such, the labels may pick up grease and other contaminants or the labels may be damaged during attachment.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of a feeder and a tap, and the feeder is used for separating an adhesive component from a tap.

FIG. 2 shows another isometric view of the tap of FIG. 1.

FIG. 3 is an enlarged view of circle III in FIG. 1.

FIG. 4 is partial view of the feeder to FIG. 1 but viewed the feeder from another angle.

FIG. 5 is partial view of the feeder to FIG. 1 but viewed the feeder from another angle.

### DETAILED DESCRIPTION

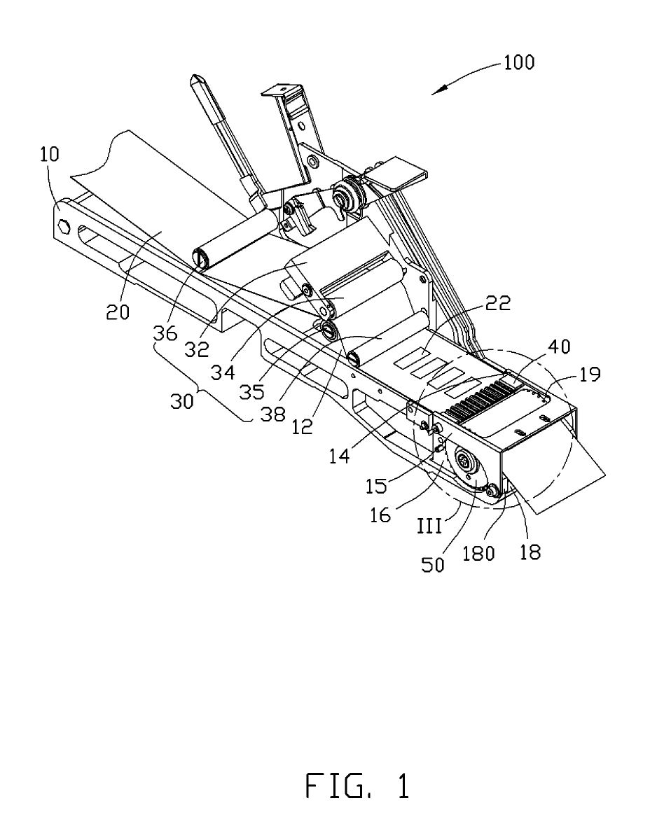

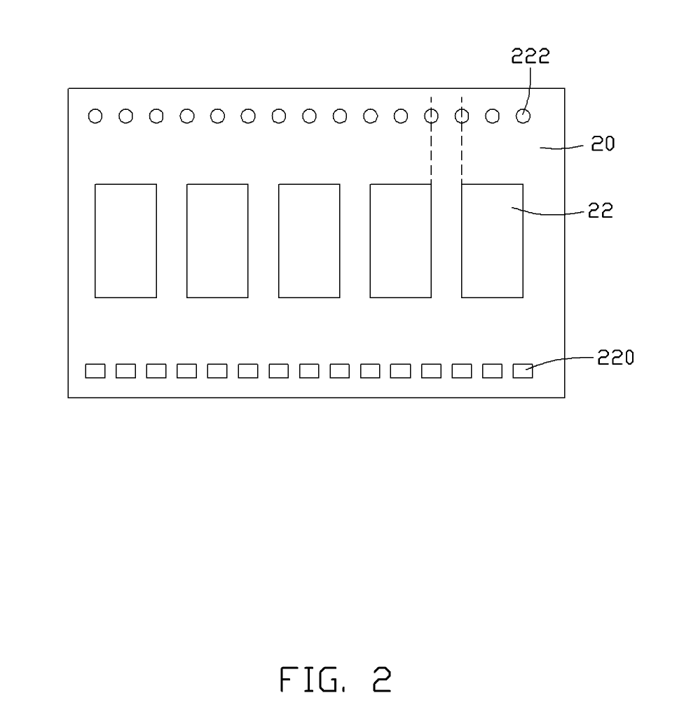

Referring to FIGS. 1 and 2, a feeder 100, in accordance with an embodiment, is shown. The feeder 100 is capable of separating an adhesive component 22 from a tap 20. The adhesive component 22 may be a label, an insulating plate, a cushion, for example. In the embodiment, the adhesive component 22 is a label. Typically, the tap 20 is wound as a roll, and has a free end without the adhesive component 22.

The tap 20 defines a plurality of first through holes 222, and a plurality of second through holes 220. The first through holes 222 and the second through holes 220 are respectively arranged at opposite sides of the tap 20. The first through holes 222 are circular and arranged in a first line at a first equal interval. The second through holes 222 are rectangular and arranged in a second line at second equal interval. The second line is parallel to the first line, and the first interval is equal to the second interval, thus each first through hole 222 corresponds to one of the second through holes 220. A sequence of adhesive components 22 are separately affixed on the middle portion of the tap 20, and between the first line and the second line of holes. There is a gap between each two adjacent adhesive components 22.

The feeder 100 includes a frame 10, a tensioning device 30, a separator 40, and a drive device 50. The tensioning device 30, the separator 40 and the drive device 50 are mounted to the frame 10. The tap 20 is unwound, and passes through the tensioning device 30, the separator 40 and the drive device 50 in sequence. The tensioning device 30 is capable of tightening the tap 20 to enable the tap 20 to pass through the separator 40. The separator 40 is capable of separating the adhesive components 22 from the tap 20 and loading each peeled adhesive components 22. The drive device 50 drives the tap 20 to be unwound and passed through frame 10.

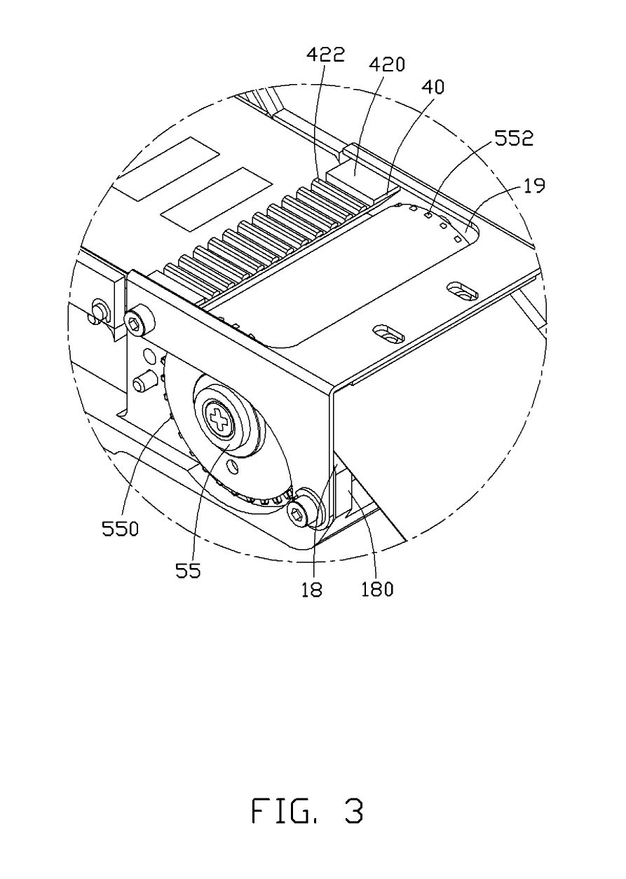

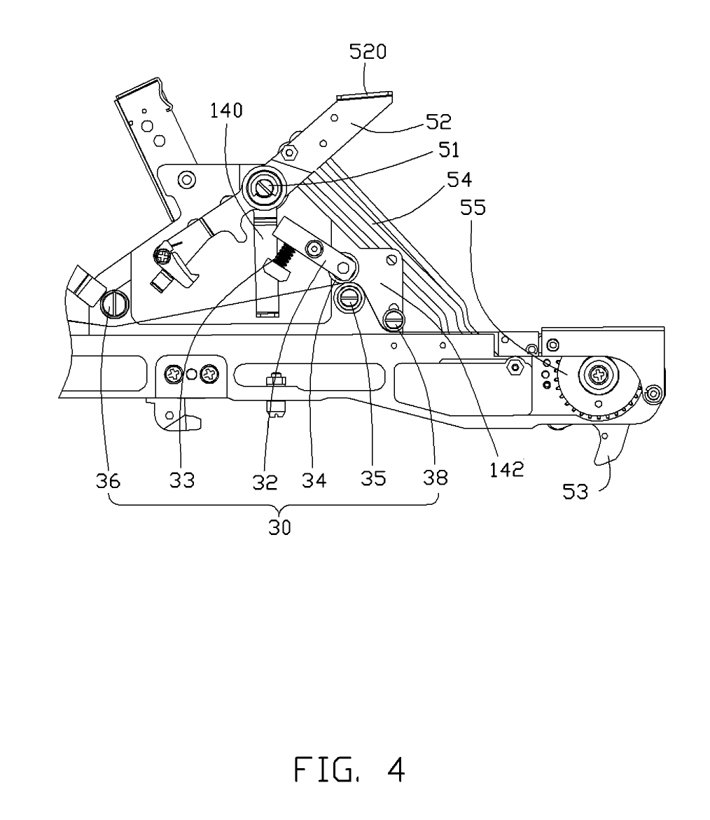

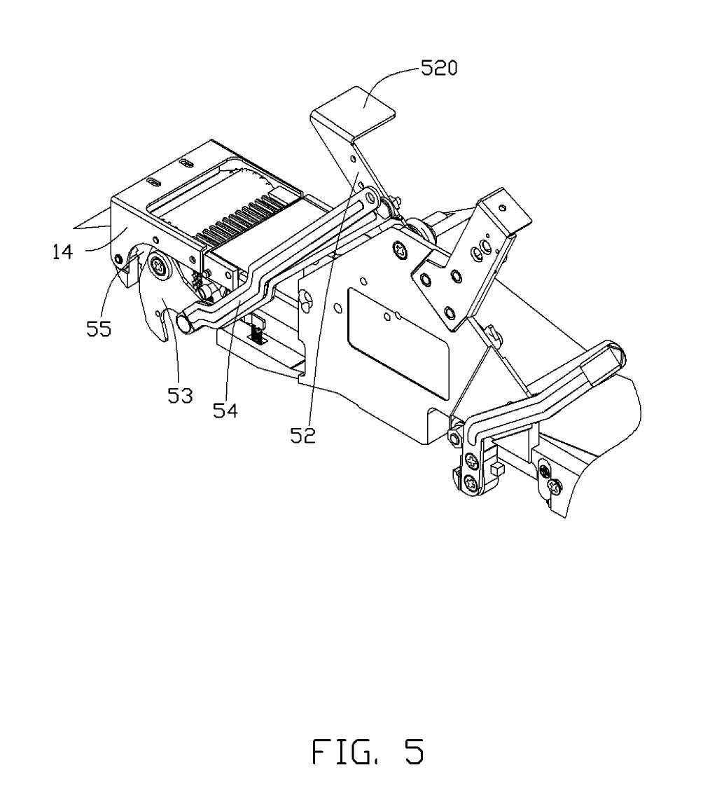

Referring to FIGS. 1, 3-5, the frame 10 includes a rectangular top portion 12, a first sidewall 14, a second sidewall 15, a fixing board 140, and a supporting member 180. The frame 10 further defines receiving cavity 16, a first opening 18, and a second opening 19. The top portion 12 is rectangular and supports the tap 20. The first sidewall 14 and the second sidewall 15 perpendicularly extend from opposite sides of the top portion 12. The first sidewall 14 extends upwards and downwards from the top portion 12. The second sidewall 15 extends downwards from the top portion 12. The fixing board 140 is fastened to the first sidewall 14 and perpendicular to the top portion 12. The receiving cavity 16 is defined in the top portion 12, the first side board 14, and the second side wall 15. The receiving cavity 16 is positioned in one end of the frame 10. The first opening 18 is defined between the first side wall 14 and the second side wall 15, and the first opening 18 communicates with the receiving cavity 160. The second opening 19 is defined in the top portion 12, and the second opening 19 communicates with the receiving cavity 160. The supporting member 180 extends from the second sidewall 15 towards the first sidewall 14. The supporting member 180 is adjacent to the first opening 18 and under the top portion 12. The supporting member 180 is capable of supporting the tap 20 to enable the tap 20 to smoothly pass through the first opening 18.

The tensioning device 30 is arranged on the top portion 12. The tensioning device 30 includes a mounting portion 32, an elastic member 33, a first idler roller 34, a second idler roller 35, a third idler roller 36, and a fourth idler roller 38.

The mounting portion 32 is rectangular. The mounting portion 32 is secured to the first sidewall 14 and above the top portion 12. The mounting portion 32 is inclined toward the top portion 12. The elastic member 33 is a spring with one end being fastened to the fixing board 140, the other end being fastened to one end of the mounting portion 32 for perpendicularly supporting the mounting portion 32. The first idler roller 34 is rotatably mounted to the other end of the mounting portion 32. The second idler roller 35 is rotatably mounted to the first sidewall 14 and under the first idler roller 34. The second idler roller 35 is parallel to the first idler roller 34, there is a first space (not labeled) formed between the first idler roller 34 and the second idler roller 35 to allow the unwound tap 20 to pass through. The elastic member 33 provides an elastic force to enable the first idler roller 34 to press the tap 20 using a consistent force.

The third idler roller 36 and the forth idler roller 38 are positioned at opposite sides of the first and the second idler rollers 34, 35. The third idler roller 36 and the top portion 12 forms a second space (not labeled) therebetween. The fourth idler roller 38 and the top portion 12 forms a third space (not labeled) therebetween. The forth idler roller 38 is adjacent to the second opening 19. The tap 20 is passed through the first space, the second space, and the third space in sequence.

The separator 40 is rectangular and parallel to the top portion 12. The separator 40 is adjacent to one side of the second opening 19 away from the end of the frame 10. The opposite ends of the separator 40 are secured to the first and the second sidewalls 14 and 15, and a fifth space (not labeled) is formed between the separator 40 and the top portion 12 to allow the tap 20 without the adhesive components 22 passing through. In other words, the width of the separator 40 is larger than the tap 20. The distance between separator 40 and the top portion 12 is smaller than the sum of the thickness of the tap 20 and the thickness of one adhesive component 220. Therefore, the adhesive components 22 are separated from the tap 20 when the tap 20 passes through the fourth space. The separator 40 includes a loading surface 420 opposite from the top portion 12 to load each peeled adhesive component 22. The peeled adhesive components 22 will move along the loading surface 420 to a proper position of the loading surface 420 under inertia. The loading surface 420 projects a plurality of ribs 422 at intervals, and the ribs 422 are parallel to the first sidewall 14 and the second side wall 15, as a result, friction resulting from the peeled adhesive components 22 moving along the loading surface 420 is reduce, and the peeled adhesive components 22 moves to the proper position.

The drive device 50 includes an elastic element 51, an operating shank 52, a pawl 53, a connecting shank 54, and a drive roller 55. The middle of the operating shank 52 is rotatably connected to the fixing board 140 via the elastic element 51. The operating shank 52 is inclined toward the top portion 12, as a result, one end of the operating shank 52 is adjacent to the top portion 12, the other end of the operating shank 52 is away from the top portion 12. The end of the operating shank 52 away from the top portion 12 projects an operating board 520 which can be operated manually or by a device (not shown) to enable the operating shank 52 to rotate. The elastic element 51 is distorted when the operating shank 52 is operated to provide an elastic force to enable the operating shank 52 to return to an original state.

The drive roller 55 is received in the receiving cavity 16. An axis of the drive roller 55 is perpendicular to the first sidewall 14 and the second sidewall 15. A plurality of first tabs 552 and a plurality of second tabs 550 protrude from the roller surface of the drive roller 55. The first tabs 552 and second tabs 550 all surround the drive roller 55 at intervals. The first tabs 552 and the second tabs 550 are respectively adjacent to opposite ends of the drive roller 55, which are adjacent to the first and the second sidewalls 14 and 15. Distances between each two first through holes 222, each two second holes 220, each two first tabs 552, and each two second tabs 550 are identical. After the unwound tap 20 is passed through the separator 40, the unwound tap 20 is passed through the frame 10 via the drive roller 55 and the first opening 18. At this time, the tap 20 is on the roller surface of the drive roller 55, the first through holes 222, and the second through holes 220 are capable of being inserted by the first tab 552, and the second tabs 550.

The pawl 53 is rotatably connected to one end of the drive roller 55, and is adjacent to the first tabs 552 and is capable of engaging with the first tabs 552. One end of the connecting shank 54 is connected to the operating shank 52. The other end of the connecting shank 54 is connected to the pawl 53. As a result, the connecting shank 54 is capable of driving the pawl 53 to rotate to drive the drive roller 155 to rotate. As a result, the tap 20 is unwound and passed through the frame 10.

As described above, the feeder 100 is capable of separating the adhesive components 22 from the tap 20 when the drive board 520 is operated. It is more convenient than separating the adhesive components 22 from the tap 20 manually.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A feeder for transferring and separating an adhesive component on a tap, the feeder comprising:
a frame having a top portion for supporting the tap;
a separator mounted to the frame to separate the adhesive component from the tap when the tap passes through the separator; and
a drive device for driving the tap to pass through the separator.

2. The feeder of claim 1, wherein the separator comprises a loading surface opposite to the top portion, the peeled adhesive component is capable of being loaded on the loading surface when the tap moves forward.

3. The feeder of claim 1, wherein the distance between the separator and the top portion is smaller than the sum of the thickness of the tap and the adhesive component.

4. The feeder of claim 1, wherein the drive device comprises a drive roller rotatably mounted to the frame, a plurality of first tabs, and a plurality of second tabs protruding from a roller surface of the drive roller, the first tabs and the second tabs are capable of being inserted into through holes defined in the tap to hold the tap and to drive the tap to move forward when the drive roller rotates.

5. The feeder of claim 4, wherein the frame defines a receiving cavity to rotatably receive the drive roller, the frame defines a first opening communicating with the receiving cavity, the tap passes through the receiving cavity and the first opening in sequence to transfer out of the frame.

6. The feeder of claim 5, wherein the top portion further defines a second opening communicating with the receiving cavity to enable the first tabs and the second tabs to be inserted to the through holes defined in the tap.

7. The feeder of claim 6, wherein the frame further comprises a supporting member which is adjacent to the first opening and under the top portion to support the tap to enable the tap to smoothly pass through the first opening.

8. The feeder of claim 1, further comprising a tensioning device, the tensioning device tightening the tap to enable the tap to smoothly transfer to the separator.
